(19) United States
(12) Patent Application Publication
(10) Pub. No.: US 2015/0264113 A1
(43) Pub. Date: Sep. 17, 2015

(54) Dynamic Batching

(71) Applicants: David Anthony Nickens, Morgan Hill, CA (US); Murthy Jayanthi, Campbell, CA (US); Jogendar Singh, Fremont, CA (US); Zhenyin Yang, Saratoga, CA (US); Deepak Sharma, Fremont, CA (US)

(72) Inventors: David Anthony Nickens, Morgan Hill, CA (US); Murthy Jayanthi, Campbell, CA (US); Jogendar Singh, Fremont, CA (US); Zhenyin Yang, Saratoga, CA (US); Deepak Sharma, Fremont, CA (US)

(73) Assignee: EBAY INC., SAN JOSE, CA (US)

(21) Appl. No.: 14/208,464

(22) Filed: Mar. 13, 2014

(51) Int. Cl. H04L 29/08

(52) U.S. Cl. CPC H04L 67/10; H04L 67/02

(57) ABSTRACT

An application running on a user device may communicate with a server application. The server application may track user actions on the device. The user actions may be transmitted from the user device to the server application using data packets. Each data packet may include header information and information regarding one or more user actions (the “batch”). The number of user actions to include in each batch may be determined by the OS, by the application, by the user, by the network, the number of actions in the batch, the size of the data in the batch, the time elapsed between the first and last action in the batch, or any suitable combination thereof. A communication server may recognize a batch data packet and divide it into individual data packets.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2014, All Rights Reserved.

### TECHNICAL FIELD

The subject matter disclosed herein generally relates to the processing of data. Specifically, the present disclosure addresses systems and methods for the batching of data generated by user interactions with a device.

### BRIEF DESCRIPTION OF THE DRAWINGS

Some embodiments are illustrated by way of example and not limitation in the figures of the accompanying drawings.

FIG. 1 is a network diagram illustrating a network environment, in accordance with an example embodiment, suitable for dynamic batching.

FIG. 2 is a block diagram illustrating components of a user device, in accordance with an example embodiment, suitable for dynamic batching.

FIG. 3 is a block diagram illustrating components of a communication server, in accordance with an example embodiment, suitable for dynamic batching.

FIG. 4 is a block diagram illustrating a data packet, in accordance with an example embodiment, suitable for dynamic batching.

FIG. 5 is a block diagram illustrating a batch data packet, in accordance with an example embodiment, suitable for dynamic batching.

FIG. 6 is a flowchart illustrating operations of a client device, in accordance with an example embodiment, suitable for dynamic batching.

FIG. 7 is a flowchart illustrating operations of a communication server, in accordance with an example embodiment, suitable for dynamic batching.

FIG. 8 illustrates some of the factors that may be considered, in accordance with an example embodiment, in determining a batch size for dynamic batching.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to dynamic batching. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

An application running on a user device may communicate with a server application. The server application may track user actions on the device, such as cursor movements, key presses, screen touches, mouse clicks, device orientation changes, and so on. The user actions may be transmitted from the user device to the server application using data packets. Each data packet may include header information, such as a device identifier, an operating system (OS) name or version, an application name or version, and so on. Each data packet may include information regarding one or more user actions, such as the type of action, the time of the action, the location of the action, and the like.

Determining the number of user actions to include in each packet may involve trade-offs. For example, transmitting each action as soon as it occurs may enable the server application to react more quickly to the user actions. As another example, batching the user actions into large batches may reduce the bandwidth required by reducing the duplication of data in the data packet (e.g., by causing one header to be sent for many user actions instead of one header for each user action).

The batch size may be determined by the OS, by the application, by the user, by the network, or any suitable combination thereof. For example, an OS may set a default batch size of five actions per batch. An application may override the default batch size to use a batch size of two actions per batch. The user may set a configuration option in the application or OS to use a batch size of ten actions per batch, causing the batch size to be set accordingly.

The batch size may be defined by the number of actions in the batch, the size of the data in the batch, or any suitable combination thereof. For example, the batch size may be ten actions, four kilobytes, ten actions and four kilobytes (e.g., a batch may not be considered full unless it contains at least ten actions and at least four kilobytes of data), or ten actions or four kilobytes (e.g., a batch may be considered full as soon as it contains either ten actions or four kilobytes of data).

Different user actions may correspond to different data sizes. For example, a mouse click action may generate data indicating that the action was of the mouse click type, the application that the click was sent to, the (x,y) coordinates of the click, and the time of the click. A screen touch action may have all of the elements of a mouse click action, plus an additional value for the pressure of the touch. Accordingly, data storing a screen touch action may be larger than data storing a mouse click action. A batch size that is set by the size of the data may include fewer actions in the batch when the actions consume more data than when the actions consume less data. For example, using a particular configuration, four screen touch actions may be included in a batch while five mouse click actions would be included. As another example, screen touches may be considered high-priority actions and not batched while key presses may be considered low-priority actions and transmitted in large batches. Naturally, other priority and batch size combinations are within the scope of the invention.

The batch size may be based on the time elapsed between the first and last action in the batch. For example, a first user action may be stored as the first action in a batch. If a second user action is received within a predetermined window (e.g., 15 seconds), then the second user action is added to the batch. If no second user action is received before the elapse of the window, the first action may be sent alone. In some example embodiments, the window will reset after the addition of each new user action to the batch and expires after the elapse of time is measured from the last action added to the batch. In other example embodiments, the window does not reset, and expires after the elapse of time is measured from the first action in the batch.

A communication server may receive a batch data packet destined for an application that expects to receive user actions in individual data packets. The communication server may recognize the batch data packet and divide it into individual data packets. For example, the header of the batch data packet may be extracted from the batch data packet. Likewise, data for each user action may be extracted from the batch data packet. The communication server may prepend the shared header to the data for each user action, creating a separate data packet for each user action. The new data packets may be transmitted to the application for processing as though they had been sent as individual data packets.

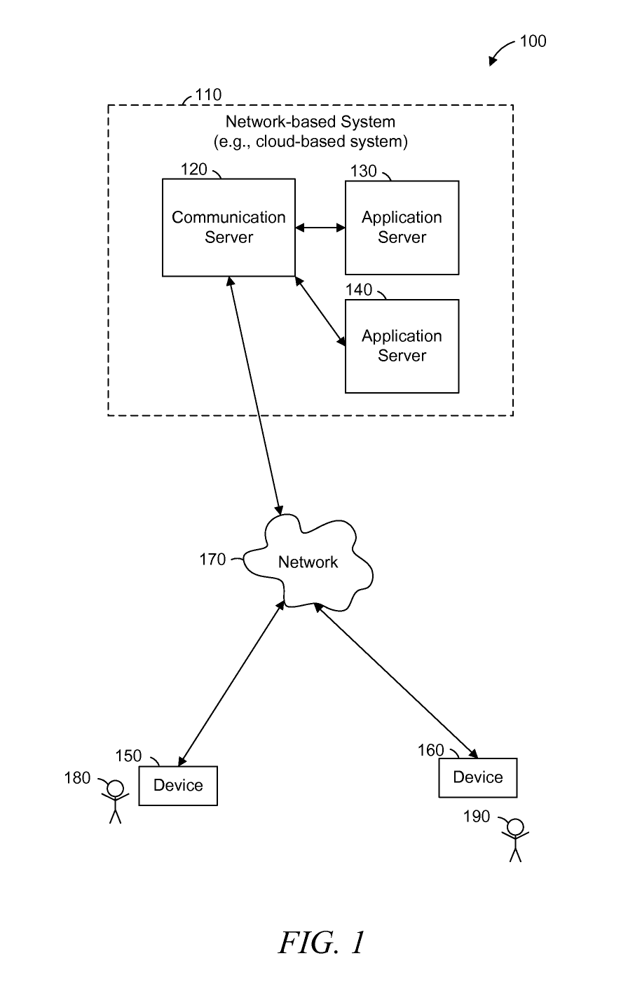

FIG. 1 is a network diagram depicting a client-server system 100, within which one example embodiment may be deployed. A network-based system 110 may include one or more servers 120-140 interacting via a network 170 with one or more client devices 150-160. The network 170 may be, for example, the Internet or a wide area network (WAN). Each server 120-140 or client device 150-160 may be a personal computer (PC), a tablet PC, a set-top box (STB), a personal digital assistant (PDA), a cellular telephone, a smart phone, a tablet, a wearable device (e.g., a smart watch or smart glasses), a web appliance, a network router, switch or bridge, or any machine capable of executing instructions (sequential or otherwise) that specify actions to be taken by that machine.

FIG. 1 illustrates, for example, a communication server 120 that acts as a gateway for application servers 130 and 140. In some example embodiments, the communication server 120 is integrated with the application servers 130 and 140 and provides application services to the client devices 150-160. In other example embodiments, the communication server 120 passes communications between each application server 130-140 and the client devices 150-160.

While the system 100 shown in FIG. 1 employs a client-server architecture, the present invention is of course not limited to such an architecture, and could equally well find application in a distributed, or peer-to-peer, architecture system, for example.

The client devices 150 and 160 may run applications that present information to their users. For example, the user 180 may use the client device 150 while the user 190 uses the client device 160. The user 180-190 may interact with the device 150 or 160, for example by entering text, moving a mouse, recording sound, touching a screen, tilting the device, taking a picture, or otherwise providing input to the device 150 or 160. The client device 150 or 160 may transmit data reflecting these inputs, or results generated from these inputs, to the communication server 120. Collectively, these inputs and results are referred to as “user actions.” As discussed in more detail below, the user actions may be collected into batches prior to transmission to the communication server 120.

The communication server 120 may manipulate the data in the batches to create individual communications for each user action. The communication server 120 may determine the application server 130-140 to receive the individual communication, and transmit the individual communication to the determined application server 130 or 140.

Also shown in FIG. 1 are users 180 and 190. One or both of the users 180 and 190 may be a human user, a machine user (e.g., a computer configured by a software program to interact with the client device 150 or 160), or any suitable combination thereof (e.g., a human assisted by a machine or a machine supervised by a human). The users 180 and 190 are not part of the client-server system 100, but are associated with the client devices 150 and 160, respectively.

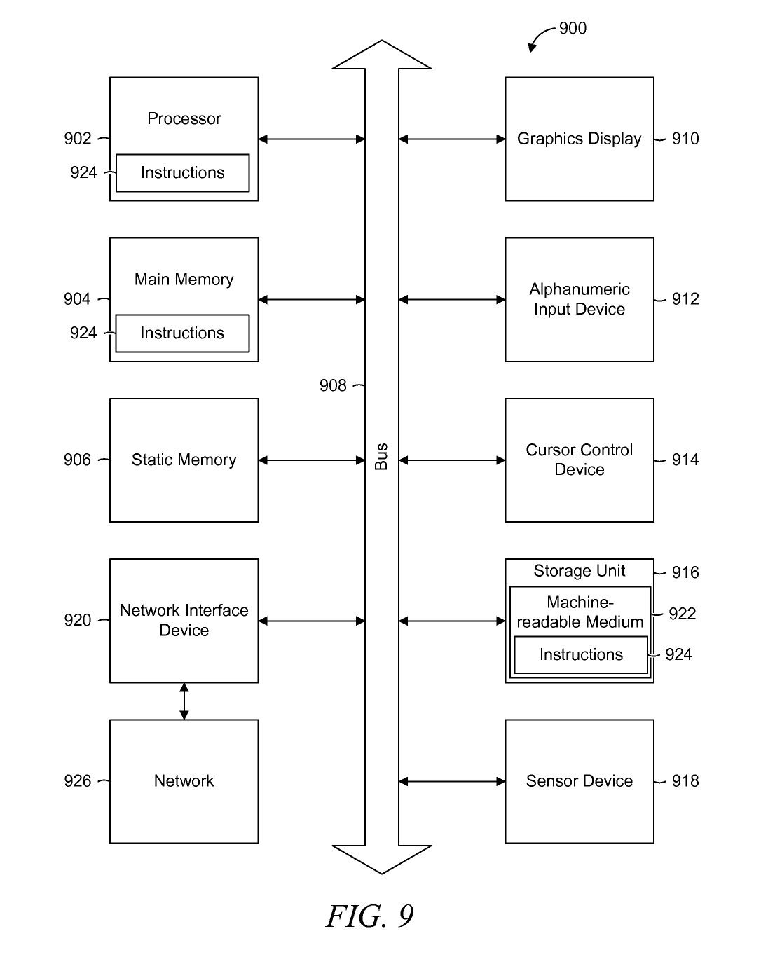

Any of the machines or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 170 may be any network that enables communication between or among machines, databases, and devices (e.g., the server 120 and the device 150). Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

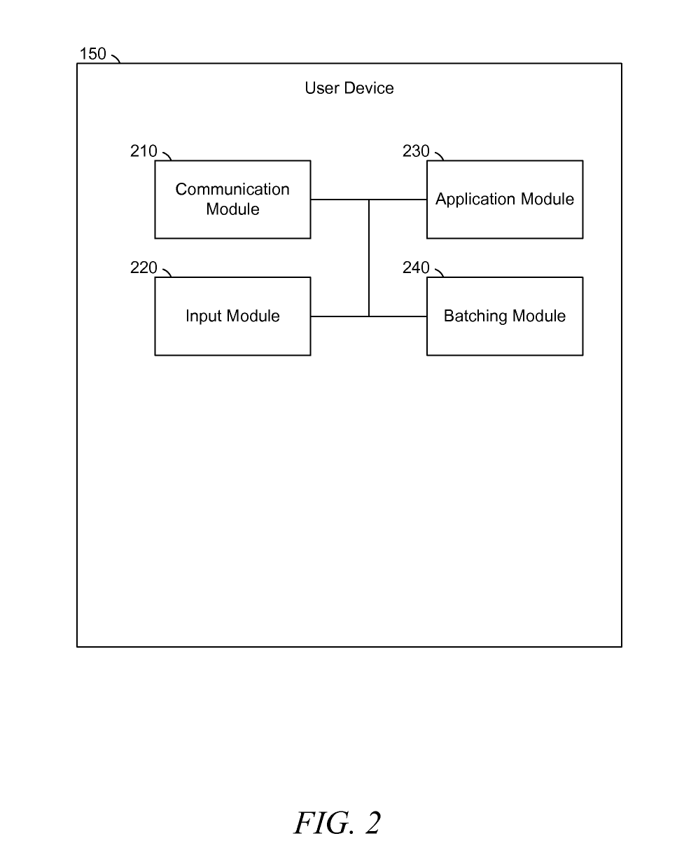

FIG. 2 is a block diagram illustrating components of a client device 150 or 160 performing dynamic batching, according to some example embodiments. The client device 150 or 160 is shown as including a communication module 210, an input module 220, an application module 230, and a batching module 240, all configured to communicate with each other (e.g., via a bus, shared memory, a switch, or application programming interfaces (APIs)). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 may send data to the communication server 120 and receive data from the communication server 120. For example, an application running on the device using the application module 230 may use the communication module 210 to communicate with a corresponding application server.

The input module 220 may receive user inputs for the device 150 or 160. The user inputs may be communicated to a server via the communication module 210, sent to the batching module 240, sent to the application module 230, or any suitable combination thereof. For example, user inputs may be sent from the input module 220 to the application module 230 to generate a response to the user from the application. The same user inputs may be sent from the input module 220 to the communication module 210 for transmission to the communication server 120.

The application module 230 may receive user inputs from the input module 220 and generate a response for the user. For example, the user input may be a key press and the application module 230 may respond by causing a character to be displayed on a screen of a device, by causing a sound file to be played, or in a variety of other ways. The application module 230 may send the user input to the batching module 240 for processing, to the communication module 210 for transmission to the communication server 120, or both.

The batching module 240 may process user inputs received from the input module 220 or the application module 230 to generate batches of inputs. The batches of inputs may be sent to the communication module 210 for transmission to the communication server 120. Each batch of inputs may contain one or more user inputs. As discussed in more detail below, the size of the batch may be based on the device, the operating system, the application, the user, or other factors.

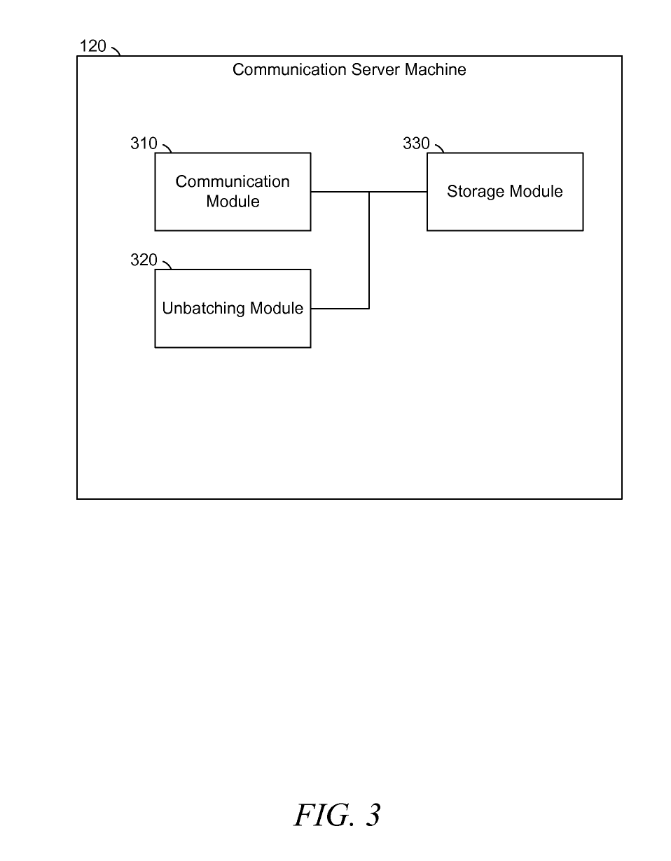

FIG. 3 is a block diagram illustrating components of a communication server 120, according to some example embodiments. The communication server 120 is shown as including a communication module 310, an unbatching module 320, and a storage module 330, all configured to communicate with each other (e.g., via a bus, shared memory, a switch, or application programming interfaces (APIs)). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 310 may control communication with the client device 150 or 160. The communication module 310 may also communicate with the application server 130 or 140.

Upon receiving a batch of user inputs from a user device (e.g., the client device 150 or 160), the communication module 310 may send the batch to the unbatching module 320 for division into the constituent user inputs. After the batch is unbatched by the unbatching module 320, the communication module 310 may transmit the individual inputs to application servers 130 or 140.

The unbatching module 320 may use the storage module 330 to store and retrieve data regarding the user inputs. For example, the first batch received from a device may include information regarding the device that changes infrequently. This infrequently-changing information may be stored via the storage module 330, along with a device identifier. Subsequent batches may include the device identifier and omit the infrequently-changing information. The unbatching module 320 may use the device identifier to retrieve the infrequently-changing information from the storage module 330. Accordingly, the individual data packets created by the unbatching module 320 may each include the infrequently-changing information while the client device 150 or 160 only sent the information once (or at some other frequency). As a result, the application servers 130 and 140 can be designed to expect data packets reflecting user actions to include more related information than the client device 150 or 160 sends, and bandwidth is saved over an implementation that transmits the larger data packets each time.

The unbatching module 320 may divide each batch into multiple data packets. For example, a batch may contain multiple user actions. After receiving the batch, the unbatching module 320 may create a new data packet for each user action in the batch. The batch may contain only a single header, containing information that is relevant to or associated with each user action in the batch. The new data packet for each user action in the batch may include the header and the data for the user action. The new data packets may be transmitted to the application servers 130 or 140. The header or user action data may indicate which application server 130 or 140 the new data packets should be sent to. For example, the client device 150 or 160 may be running two applications, each of which is communicating user actions to a different application server 130 or 140. Each application may generate a separate batch, and the header of each batch may identify the application using a name or alpha-numeric identifier. Based on the application data in the header, the individual data packets from the batch may be sent to the application server 130 or 140 that is serving the application.

Though this detailed description discusses user actions, it will be appreciated by one of skill in the art that particular forms of user actions may be used. For example, user actions may include key presses, mouse clicks, mouse hovers, screen touches, screen swipes, multi-touches, audio input, and video input. In some example embodiments, only a subset of the user actions are considered. For example, only screen touches may be considered. Additionally, different types of user inputs may be considered in a single embodiment. To illustrate, an example embodiment may consider any form of user input with a first application to be a user action but consider only screen touches with a second application to be a user action. Thus, while the description below frequently refers to user actions, the various possible combinations of types of user actions should be recognized as being within the scope of the present invention.

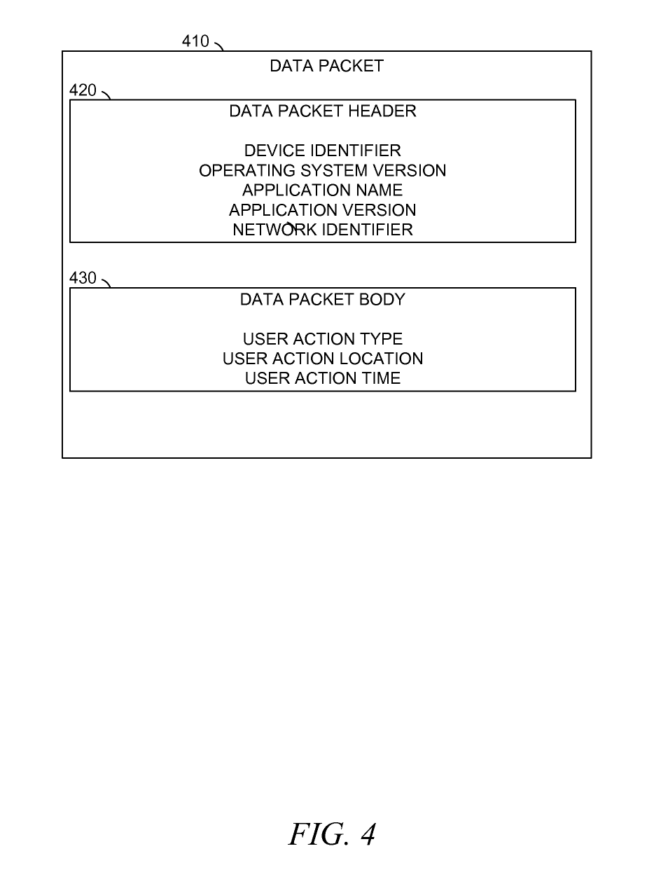

FIG. 4 is a block diagram illustrating a data packet 410, in accordance with an example embodiment, suitable for dynamic batching. The data packet 410 may contain data regarding a single user action. For example, the data packet 410 may be made up of a data packet header 420 and a data packet body 430. The data packet header 420 and the data packet body 430 may be implemented as key-value pairs in extended markup language (“XML”), as binary data in a predefined format, or in another way.

The data packet header 420 may include information providing context for the user action. For example, the data packet header 420 may include a device identifier, an operating system version, an application name, an application version, a network identifier, or any other information. In some example embodiments, information in the data packet header 420 is not specific to the user action described in the data packet body 430.

The data packet body 430 may include information describing the user action. For example, the data packet body 430 may include a user action type, a user action location, a user action time, or any other information describing the user action.

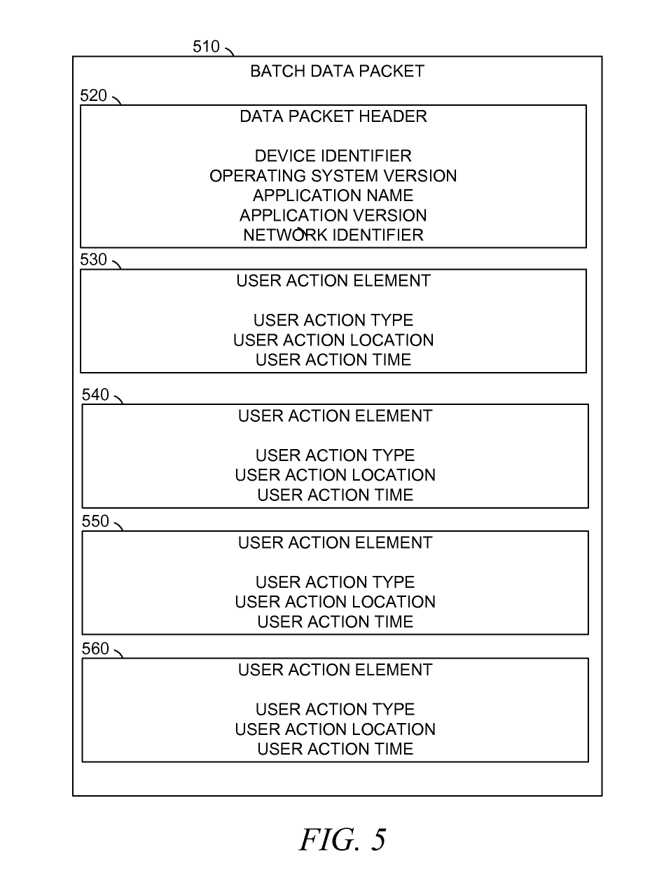

FIG. 5 is a block diagram illustrating a data packet 510, in accordance with an example embodiment, suitable for dynamic batching. The data packet 510 may contain data regarding multiple user actions. For example, the data packet 510 may be made up of a data packet header 520 and user action elements 530-560. The data packet header 520 and the user action elements 530-560 may be implemented as key-value pairs in extended markup language (“XML”), as binary data in a predefined format, or in another way.

The data packet header 520 may include information providing context for the user action, as described above with respect to the data packet header 420. In some example embodiments, the data included in the data packet header 520 is different from the data included in the data packet header 420. For example, the data packet header 520 may include information about the number of user action elements 530-560, the total size of the batch, the time period for which the batch applies, or other batch-specific data.

The user action elements 530-560 may include information describing distinct user actions. For example, the user action element 530 may include information regarding a mouse click at a certain time at a certain (x,y) location on a screen. The user action element 540 may include information regarding a second mouse click at a later time and a different location. The user action element 550 may include information regarding a key press at a certain time. The user action elements 530-560 may vary in size. For example, the user action element 550 including information regarding a key press may not include a screen coordinate, and thus be smaller than the user action element 530 including information regarding a mouse click which does include coordinate data.

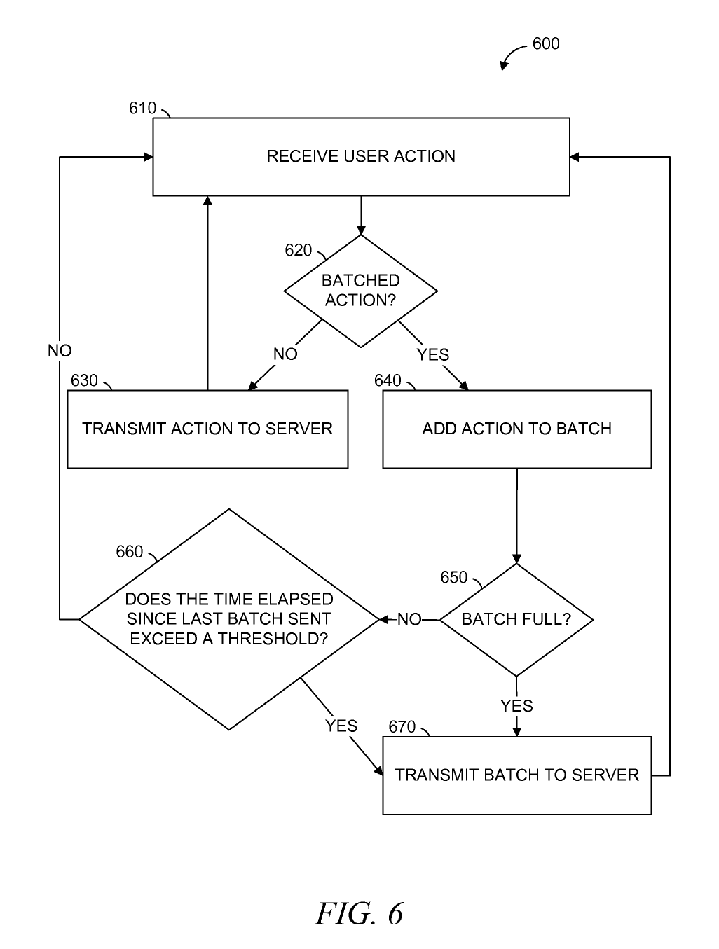

FIG. 6 is a flowchart illustrating operations of a client device 150 or 160 in performing a method 600 of dynamic batching, according to some example embodiments. Operations in the method 600 may be performed by the client device 150 or 160, using modules described above with respect to FIG. 2.

In operation 610, the client device 150 or 160 may receive a user action. For example, the user may rotate the device, touch the screen, take a picture, press a key, or otherwise interact with the device.

In operation 620, the client device 150 or 160 may determine whether the user action is a batched action. For example, in a real-time game, user actions may not be batched to reduce lag time while in a turn-based game, user actions may be batched to reduce bandwidth requirements. The determination of whether an action is batched may be determined by the application receiving the user action, by the operating system of the device 150 or 160, by the user 180 or 190 of the client device 150 or 160, or any suitable combination thereof. For example, the user 180 or 190 may set a soft preference to use batching unless an application specifically requests that batching not be used. An application may override the user's soft preference by requesting that batching not be used. As another example, the user 180 or 190 may set a hard preference to use batching. An application may request that batching not be used, but the request may be ignored due to the user's hard preference. If a determination is made that the action is not batched, control proceeds to operation 630. If a determination is made that the action is batched, control proceeds to operation 640.

Continuing with the discussion of operation 620, certain actions may be batched while others are unbatched within a single embodiment. In an example embodiment, higher-priority actions are unbatched while lower-priority actions are batched. For example, user actions that result in commands may be given a higher priority than user actions that merely provide data for later mining. Accordingly, the user commands may be transmitted immediately after generation, unbatched, while other user actions may be batched before transmission. As another example, an application may have multiple windows or screens, one of which is associated with high priority actions and the other of which is associated with low priority actions. Accordingly, actions generated in the higher-priority window or screen may be transmitted unbatched, while those generated in the lower-priority window or screen are batched prior to transmission.

In operation 630, the user action is transmitted to the communication server 120. For example, a data packet may be created with a header including information regarding the device, the operating system, and the application and a body including information regarding the user action. The data packet may be transmitted to the communication server 120. The data packet may be compressed. After the data packet is transmitted, control returns to operation 610, where the next user action is awaited.

In operation 640, the user action is added to the pending batch or a new batch is created to hold the user action. For example, a data structure with data regarding the user action may be created and stored in random access memory (“RAM”), on a hard disk, in a database, or otherwise maintained for later use.

In operation 650, a determination is made as to whether the pending batch is full. For example, a batch size of ten items may be used. For the first nine user actions, the determination would be made that the batch is not full. During processing of the tenth user action, the determination would be made that the batch is full. As another example, a minimum batch size of 1024 bytes may be used. During processing of each user action, the sum of the sizes of the data structures for each user action in the batch may be calculated. If the sum of the data sizes exceeds the minimum batch size, the determination would be made that the batch is full. If a determination is made that the current batch is not full, control proceeds to operation 660. If a determination is made that the current batch is full, control proceeds to operation 670.

In operation 660, a determination is made as to whether a threshold of time has elapsed. For example, a time limit of one minute may be set as a threshold. If more than one minute has elapsed since the receipt of the first user action of the batch, the time elapsed may exceed the threshold. The threshold may be measured against the time of the first user action of the current batch, the time the previous batch was sent, the time of the last user action of the current batch, a time on the system clock, or another time. If a determination is made that the threshold of time has elapsed, control proceeds to operation 670. Otherwise, control returns to operation 610 and awaits the next user action.

In operation 670, the current batch is transmitted to the communication server 120. For example, a data packet may be created that includes a single header and multiple data elements, each data element corresponding to one user action. The data packet may be compressed. After the data packet is transmitted, data for the user actions of the current batch may be discarded, and control returned to operation 610 to await the next user action.

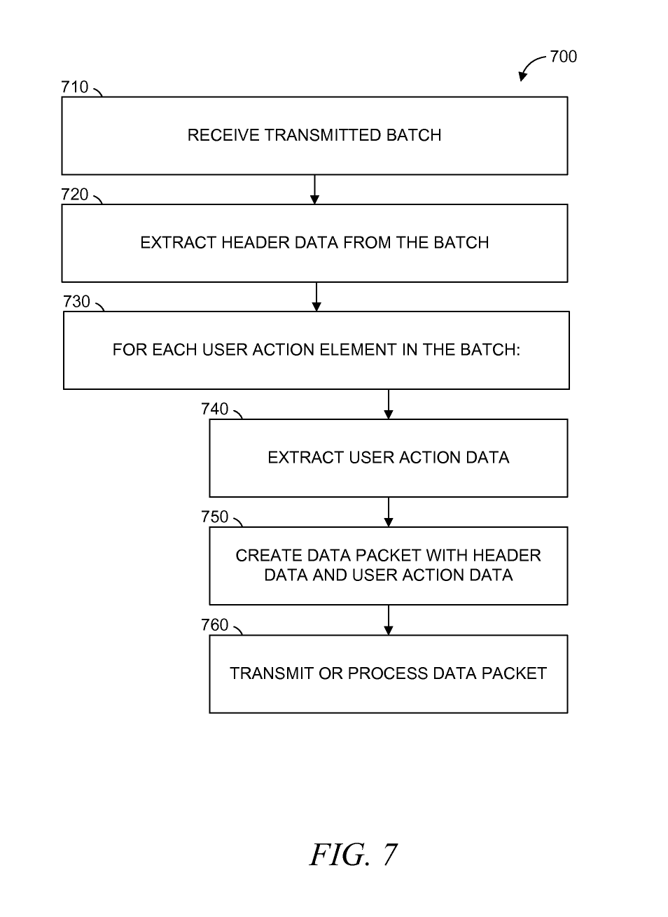

FIG. 7 is a flowchart illustrating operations of a communication server 120 in performing a method 700 of dynamic batching, according to some example embodiments. Operations in the method 700 may be performed by the communication server 120, using modules 310-330 described above with respect to FIG. 3.

In operation 710, a batch data packet is received. For example, a batch data packet may have been generated by a client device 150 or 160 using the method 600 described above. The batch data packet may be decompressed.

In operation 720, header data is extracted from the batch. For example, a batch data packet may have a structure similar to that depicted in FIG. 5, including a data packet header and multiple user action elements. The header data may be relevant for each of the multiple user action elements.

In operation 730, a loop is begun for further processing of each user action element in the batch. The loop comprises operations 740-760.

In operation 740, the body data for the present element is extracted. This may involve copying the data to a memory location or merely identifying the portion of memory corresponding to the data.

In operation 750, a data packet is created that includes the header data extracted in operation 720 and the user action data extracted in operation 740.

In operation 760, the data packet created in operation 750 is transmitted (e.g., to application server 130 or 140) or processed. The determination as to where to transmit the data packet or whether to process the packet further may be based on the header data, the user action data, settings of the communication server 120, settings of the application server 130 or 140, or any suitable combination thereof.

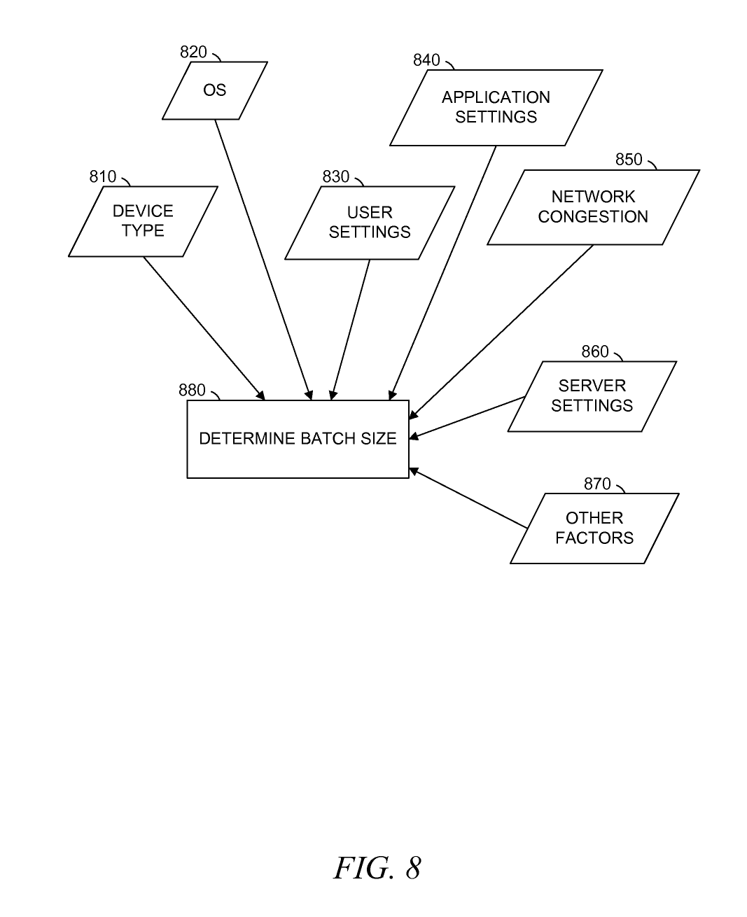

FIG. 8 illustrates some of the factors that may be considered in determining a batch size for dynamic batching. In some example embodiments, a batch size of one corresponds to disabling the use of dynamic batching. The determination of the batch size in the process 880 may depend on the device type 810, the operating system 820, the user settings 830, the application settings 840, the network congestion 850, the server settings 860, and other factors 870.

Device type 810 may be considered. For example, users using desktop or laptop computers may be more likely to be connected to the communication server via a high-bandwidth connection, so the batch size may be smaller than for users connecting via a tablet or smart phone.

Operating system 820 may also be considered. For example, batching functionality may be incompatible with certain OSes or available memory for batching may be limited on certain OSes, encouraging the use of a smaller batch size. As another example, certain OSes may be associated with use on mobile devices for which bandwidth is at a premium, encouraging the use of a larger batch size.

User settings 830 may be considered. For example, a user may set a preferred batch size for use on the device or with a certain application. As another example, a user may set a preference using a slider to select a value between “most responsive” and “least bandwidth,” with the process 880 determining the precise meaning of each value along the slider.

Application settings 840 may be considered. For example, an application that desires to provide constantly-updated data to the communication server may provide a setting for a low batch size. As another example, an application that desires to reduce bandwidth consumption may provide a setting for a large batch size. An application may have multiple screens or windows. For example, a configuration screen or window for an online game during which the user sets options and a game screen or window during which the user interacts with the game. The batch size may be based on the screen or window of the application. For example, the configuration screen may use a larger batch size than the game screen.

Network congestion 850 may be considered. For example, when the network over which the data is being transmitted is congested, devices may be requested to reduce their use of bandwidth, and a larger batch size may be used. As another example, when the network is not being fully utilized, a smaller batch size may be used.

Server settings 860 may be considered. For example, receiving batched packets may cause additional processing to be performed on the communication server, and a lower batch size may be used when the processing capabilities of the server are stressed. As another example, receiving batched packets may reduce the bandwidth required to support each device, and a larger batch size may be used when many devices are communicating with the server.

Other factors 870 may be considered. For example, the time of day, the location of the device, the types of inputs being received, the battery level on the device, the price of bandwidth on the network, and so on.

In the process 880, the size of the batch to use is determined, based on the foregoing and other factors. The size of the batch determined by the process 880 may be the batch size used in the method 600, discussed above.

According to various example embodiments, one or more of the methodologies described herein may facilitate dynamic batching. Hence, one or more of the methodologies described herein may facilitate efficient network and processor use. Reducing the batch size may enable a server to be more responsive to user actions on a client device. Increasing the batch size may enable a client device to reduce the bandwidth used in communicating user actions to a server device.

When these effects are considered in aggregate, one or more of the methodologies described herein may obviate a need for certain efforts or resources that otherwise would be involved in sending and receiving data. Computing resources used by one or more machines, databases, or devices (e.g., within the client-server system 100) may similarly be reduced. Examples of such computing resources include processor cycles, network traffic, memory usage, data storage capacity, power consumption, and cooling capacity.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures may be employed. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a smart phone, a tablet, a wearable device (e.g., a smart watch or smart glasses), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a disk drive unit 916, a sensor device 918 (e.g., a gyroscope, microphone, or camera) and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more modules configured to:
identify a first plurality of user actions on a device;
for each first user action of the first plurality of user actions:
create a first data packet including data regarding the device and the first user action, and
transmit the first data packet to a server;
identify a second plurality of user actions on the device;
create a second data packet including data regarding the device and each second user action of the second plurality of user actions;
transmit the second data packet to the server.

2. The system of claim 1, wherein the data regarding the device includes a device identifier and an operating system version.

3. The system of claim 1, wherein each second user action of the second plurality of user actions occurs within a predetermined time span.

4. The system of claim 1, wherein the one or more modules are further configured to:
identify a third user action on the device; and
add the third user action to the second plurality of user actions based on a type of the third user action.

5. The system of claim 4, wherein the one or more modules are further configured to:
identify a fourth user action on the device; and
add the fourth user action to the first plurality of user actions based on a type of the fourth user action.

6. The system of claim 1, wherein the second plurality of user actions has a size and the size of the second plurality of user actions equals a predetermined size.

7. The system of claim 6, wherein the predetermined size is a measure of memory consumption.

8. The system of claim 6, wherein the predetermined size is a quantity of user actions.

9. The system of claim 1, wherein the one or more modules are further configured to:
identify a third user action on the device, the user action being an interaction with a first application;
add the third user action to the second plurality of user actions based on a configuration of the first application.

10. The system of claim 9, wherein the one or more modules are further configured to:
identify a fourth user action on the device, the user action being an interaction with a second application;
add the fourth user action to the second plurality of user actions based on a configuration of the second application.

11. A method comprising:
identifying a first plurality of user actions on a device;
for each first user action of the first plurality of user actions:
creating a first data packet including data regarding the device and the first user action, and
transmitting the first data packet to a server;
identifying a second plurality of user actions on the device;
creating a second data packet including data regarding the device and each second user action of the second plurality of user actions;
transmitting the second data packet to the server.

12. The method of claim 11, wherein the data regarding the device includes a device identifier and an operating system version.

13. The method of claim 11, wherein each second user action of the second plurality of user actions occurs within a predetermined time span.

14. The method of claim 11, further comprising:
identifying a third user action on the device; and
adding the third user action to the second plurality of user actions based on a type of the third user action.

15. The method of claim 14, further comprising:
identifying a fourth user action on the device; and
adding the fourth user action to the first plurality of user actions based on a type of the fourth user action.

16. The method of claim 11, wherein the second plurality of user actions has a size and the size of the second plurality of user actions equals a predetermined size.

17. The method of claim 16, wherein the predetermined size is a measure of memory consumption.

18. The method of claim 16, wherein the predetermined size is a quantity of user actions.

19. The method of claim 11, further comprising:
identifying a third user action on the device, the user action being an interaction with a first application;
adding the third user action to the second plurality of user actions based on a configuration of the first application.

20. A non-transitory machine-readable storage medium comprising instructions that, when executed by one or more processors of a machine, cause the machine to perform operations comprising:
identifying a first plurality of user actions on a device;
for each first user action of the first plurality of user actions:
creating a first data packet including data regarding the device and the first user action, and
transmitting the first data packet to a server;
identifying a second plurality of user actions on the device;
creating a second data packet including data regarding the device and each second user action of the second plurality of user actions;
transmitting the second data packet to the server.
